(19) United States
(12) Patent Application Publication
(10) Pub. No.: US 2004/0024849 A1
(43) Pub. Date: Feb. 5, 2004

(54) Method and system for distributing data

(76) Inventor: Adel El-Beik, Wokingham (GB)

Correspondence Address: RICHARD F. JAWORSKI, Cooper & Dunham LLP, 1185 Avenue of the Americas, New York, NY, 10036, US

(21) Appl. No.: 10/418,894

(22) Filed: Apr. 18, 2003

Related U.S. Application Data
(60) Provisional application No. 60/373,812, filed on Apr. 19, 2002.

(51) Int. Cl. G06F 15/16

(52) U.S. Cl. 709/219; 709/218

(57) ABSTRACT

A method and system of distributing data is provided. A system for data distributing data may include an update unit adapted to receive data from a remote data supplier, a catalog system adapted to send selected data to a remote user and an administration unit which received administration information from an administrator, wherein the reception of data from the data supplier and the sending of selected data to the user by the catalog unit is controlled based on the administration information. Data suppliers may register to provide data in advance and the supplied registration information may be used to authenticate the data supplier prior to receiving data from the data supplier. Users may also register to use the system and the user registration information they provide may be used to authenticate a user prior to sending data to the user. The system may be embodied as a group of web services which are linked together to perform the data distribution function. The system may communicate with the data suppliers, users and an administrator via the network using XML messages, for example.

### REFERENCE TO RELATED APPLICATIONS

The present specification is based on and claims the benefit of Provisional Application 60/373,812 filed Apr. 19, 2002, the entire contents of which are herein incorporated by reference.

### BACKGROUND

1. Field of the Disclosure

The present disclosure relates to data distribution, and more particularly, to a method and system for distributing data over a computer network.

2. Related Art

Networks, such as the internet, wireless networks, wide area networks, local area networks, etc. have made it increasingly possible for individuals to share information and corroborate. The corroboration available via networks would be even more useful if software applications and tools utilized by different people at different locations could share information easily over the network. Traditional software applications, however, tend to be designed for operations on specific platforms and tend to have specific requirements that are not readily interchangeable.

A growing trend in the computer industry, however, is the development of applications which can interact with other applications, even other applications developed by other software developers and running on other computers. Thus, the current trend is to design software applications as loosely coupled dynamically bound components which can be combined together to form new solutions. Preferably these new components would “live” on the network, that is, they would be readily accessible to others via the network. The term that has developed to describe these components is “Web Services”. Applications may be developed as a composition of web services which are discovered and bound at run time. Thus, the network (s) can be used as a new environment for the development of software applications.

As noted above, networks have made it far easier to share information. In light of this, it would be desirable to provide a data distribution system and method to facilitate distribution of data using networks.

### SUMMARY OF THE DISCLOSURE

A system for distributing data electronically via a computer network includes an update unit adapted to receive data in electronic format from at least one data supplier, a catalog unit adapted to send selected data from the data received by the update unit to a user in electronic format based on selection information and an administration unit adapted to control reception of data by the update unit and sending of selected data by the catalog unit based on administration information received from an administrator.

A method of distributing data in electronic format over a computer network includes receiving data from at least one data supplier in electronic format, sending selected data to a user in electronic format based on selection information, receiving administration information from an administrator and controlling the step of receiving data and the step of sending selected data according to the administration information.

A computer system includes a processor and a program storage device readable by the computer system, embodying a program of instructions executable by the processor to perform method steps for distributing data. The method steps include receiving data from a remote data supplier in electronic format, sending selected data to the user in electronic format, receiving administration information from a remote administrator and controlling the step of receiving data and the step of sending selected data according to the administration information.

A program storage medium, readable by a computer system, embodying a program of instructions executable by the computer system to perform method steps for distributing data in a computer network is provided. The method steps include receiving data from a remote data supplier in electronic format, sending selected data to the user in electronic format, receiving administration information from a remote administrator and controlling the step of receiving data and the step of sending selected data based on the administration information.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram illustrating a computer system for implementing a method and system according to the present disclosure.

FIG. 2 is a block diagram of a system for distributing data according to an embodiment of the present disclosure.

FIG. 3 is a block diagram of an update unit according to an embodiment of the present disclosure.

FIG. 4 is a block diagram of a catalog unit according to an embodiment of the present disclosure.

FIG. 5 is a block diagram of an administration unit according to an embodiment of the present disclosure.

FIG. 6 is a flow chart illustrating a method for distributing data according to an embodiment of the present disclosure.

FIG. 7 is a flow chart further illustrating a step of receiving data from a remote data supplier according to an embodiment of the present disclosure.

FIG. 8 is a flow chart further illustrating a step of sending selected data to a remote user according to an embodiment of the present disclosure.

FIG. 9 is a flow chart further illustrating a step of receiving administration data from a remote administrator according to an embodiment of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected and it is to be understood that each specific element includes all technical equivalents which operate in a similar manner.

The system and method may be implemented in the form of a software application running on a computer system or systems such as a mainframe, personal computer (PC), handheld computer, server etc. The computer system may be linked to a database or another computer system. The link may be, for example, via a direct link such as a direct hard wire or wireless connection, via a network connection such as a local area network, or via the network.

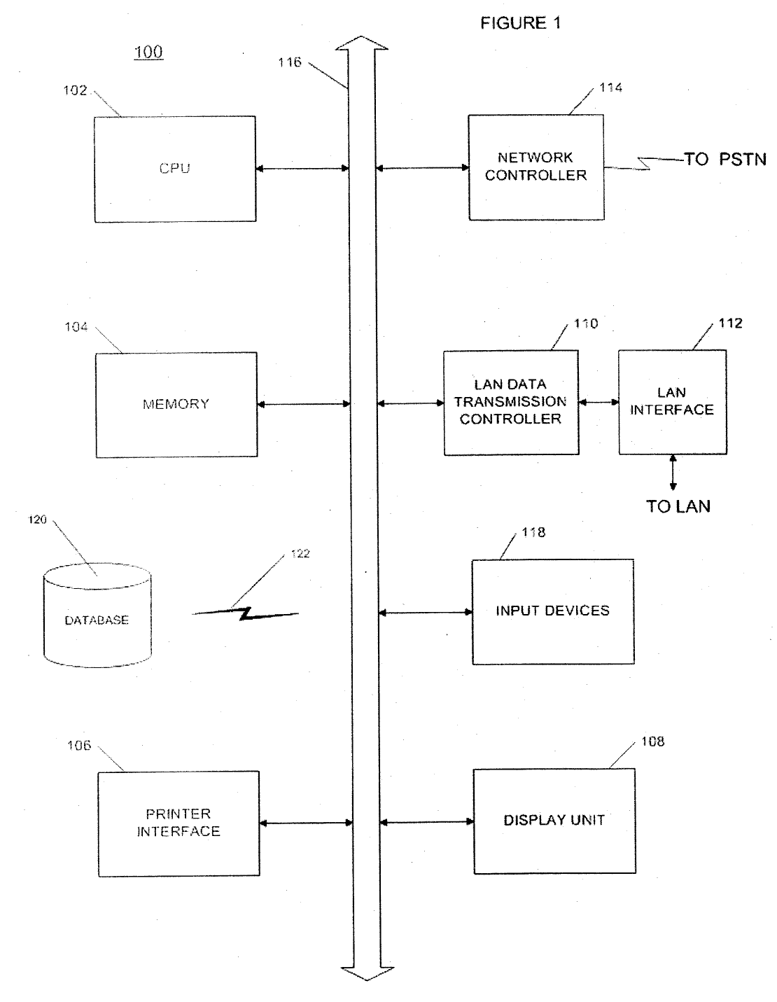

An example of a computer system capable of implementing the present system and method is shown in FIG. 1. The computer system referred to generally as system 100 may include a central processing unit (CPU) 102, memory 104, a printer interface 106, a display unit 108, a LAN (local area network) data transmission controller 110, a LAN interface 112, a network, controller 114, an internal bus 116 and one or more input devices 118 such as, for example, a keyboard, mouse, etc. As shown, the system 100 may be connected to a database 120 via a link 122.

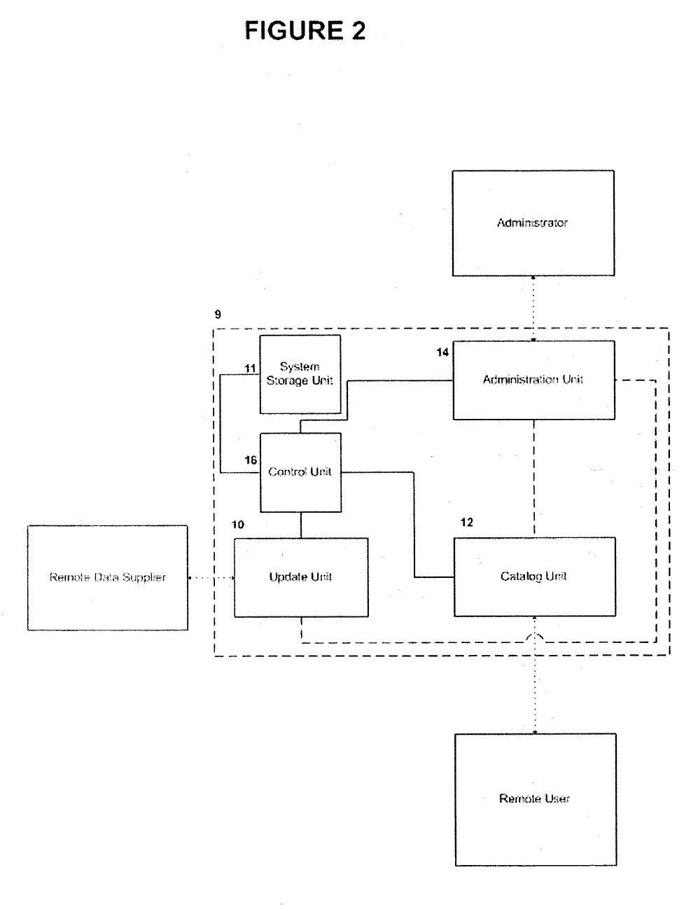

A system for distributing data 9 according to an embodiment of the present disclosure is explained with reference to FIG. 2. An update unit 10 is adapted to receive data from a remote data supplier in electronic format. A catalog unit 12 is adapted to send selected data to a remote user in electronic format. An administration unit 14 is adapted to control the reception of data bay the update unit and the sending of selected data by the catalog unit based on administration information received by the administration unit 14 from an administrator of the system 9. A control unit 16 may be used to facilitate control of the update unit 10 and the catalog unit 12 by the administration unit 14. A system storage unit 11 may be used to store data.

Preferably, the present system is implemented in the form of a web service, or a group of web services. In other words, a data distribution web service is embodied as a collection of web services which operate with each other to receive data from various remote data suppliers and to send selected data to a user, wherein the reception of data and the sending of selected data is controlled based on administration information provided by a remote administrator via an administration web service.

The web services communicate using a ubiquitous standard such as Extensible Mark-up Language (XML). Similarly, the remote users, data suppliers and administrator preferably communicate within the system 9 utilizing XML messages. These XML messages may be generated by a client agent at the user side, supplier side or administrator side and may be provided by a browser, for example. While the XML standard is specifically disclosed, any ubiquitous standard may be utilized.

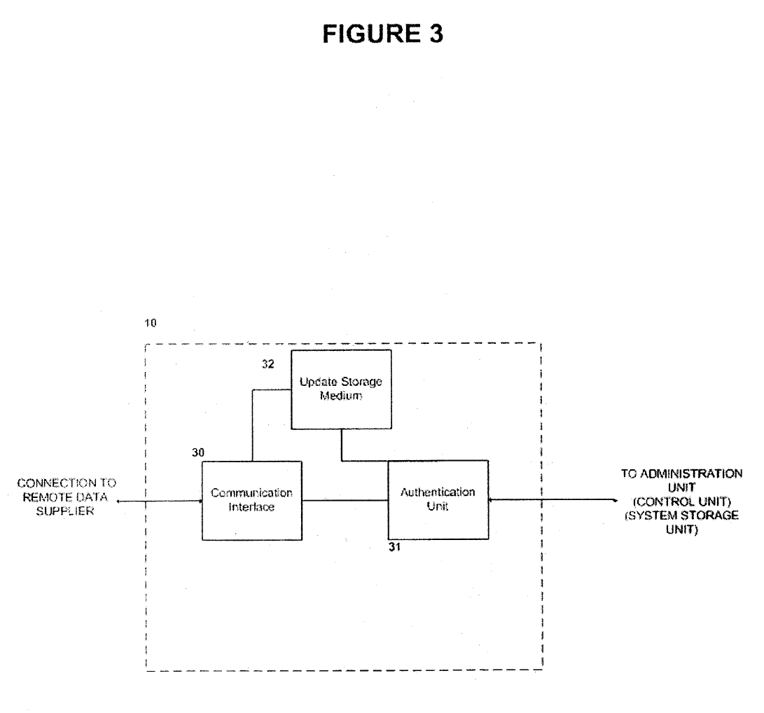

The update unit 10 is adapted to allow the system 9 to receive data from data supplies, or sources electronically, preferably over the network. The update unit 10 is described in further detail with reference to FIG. 3. The update unit 10 preferably includes a communication interface 30 which is utilized to establish a connection between a data supplier and the update unit 10, preferably using the network. More specifically, the update unit 10 connects the catalog unit, which is preferably embodied as a web service, as mentioned above, with a computer of a data supplier via the network. The communication interface also allows the update unit 10 to communication with the catalog unit 12 and the update unit 14. The update unit 10 preferably includes an authentication unit 31 which authenticates prospective data suppliers. In a preferred embodiment, data suppliers will pre-register themselves with the system 9 by providing certain supplier registration information which can be used to authenticate the data suppliers. These data suppliers are authenticated data suppliers. The supplier registration information may be provided by an administrator utilizing the administration unit 14 or may be stored in an update storage medium 32 in the update unit 10 itself. The supplier registration information may also be stored in the separate system storage medium 11. Certain permission information may also be provided for each authenticated data supplier and may be included in the registration information. For example, a data supplier may be granted permission to designate a destination folder in which the data they provide will be stored.

When a data supplier establishes contact with the system 9, the data supplier may be asked to provide supplier identification information, such as a name or identification code, for example. Communication may be established after receipt from the data supplier of a communication request, for example. The supplier identification information may be issued to the data supplier at the time of preregistration, for example, and may be included in the supplier registration information of each authenticated data supplier. The supplier identification information provided by the data supplier may be compared to identification information associated with each of the authenticated data suppliers represented in the supplier registration information using the authentication unit 31. If the supplier identification information entered by the data supplier matches identification information corresponding to one of the authenticated data suppliers, the data supplier is an authenticated data supplier and the update unit 10 may receive data from the authenticated data supplier. Otherwise, the update unit 10 may not receive data from the data supplier, or may only receive limited data, such as registration information, such that the update unit 10 will be authorized to receive data from the unauthenticated data supplier in the future.

The data received from the data supplier may be any type of data. Preferably, the data is supplied in electronic format. More specifically, the data is received via the network using a ubiquitous standard, as mentioned above. The data received from the data Supplier may include software programs, audio data or visual data, for example. The data received from the data supplier preferably includes information identifying the type of data along with the data supplied.

The data received by the update unit 10 may also include policy objects which specify certain parameters under which the data may be distributed. For example, a policy object may specify certain countries to which the data may and may not be distributed. In another example, the policy object may include a price to be charged for the download of the data.

The data is preferably received by the update unit 10 in discrete segments. In this manner, if reception of the data is interrupted, reception may continue at a later time at the point of the interruption. This may require the use of a client agent, a plug-in, for example, operating on the data supplier's computer which tracks the reception of data by the update unit 10 and maintains a record of the last segment received by the update unit 10. Client agents are discussed in further detail herein below.

Once received by the update unit 10, the data is preferably stored in a folder analogous to those used in a Windows environment. Where the data supplier has permission, the data supplier may name the destination folder in which the data is stored. In this manner, it is more convenient for a data supplier to update or to add to the data that they have already provided at a later time.

In one embodiment of the present system, the data provided by the data supplier is software. Software is preferably received in software packages, objects that contain software programs. Each software package may contain several software programs. Each software program may include several software files. As noted above, the software may be stored in a folder, or destination folder. As noted above, permission to designate the destination folder may be provided to individual authenticated data suppliers. Software may be uploaded along with other associated information like the policy objects discussed above.

After a software package has been uploaded, along with its associated information, the software package is sealed. Once sealed, the package is available for distribution by the distribution system 9. That is, the software package is available for download to certain users of the distribution system 9.

As noted above, data is preferably stored in folders on the system. The folders may be stored in the update storage medium 32 in the update unit 10, or may be stored in the separate system storage medium 11.

As noted above, the update unit 10 is preferably a web service that allows various data suppliers to supply data. It is noted that while a data supplier may be an individual, data suppliers may also be companies, such as software companies for example, that use the distribution system 9 as a convenient way to distribute their products, or updates of their products. For example, a software company can simply send an update of one of their products to the distribution system 9 via the catalog unit 10. The update is then accessible by many different individuals utilizing the distribution system 9 simply by accessing the distribution system via the network. Thus, the software company has the ability to allow all of its customers to update their product from a commonly available source. In addition, the company need not consume their own network resources in order to make the update available to their users.

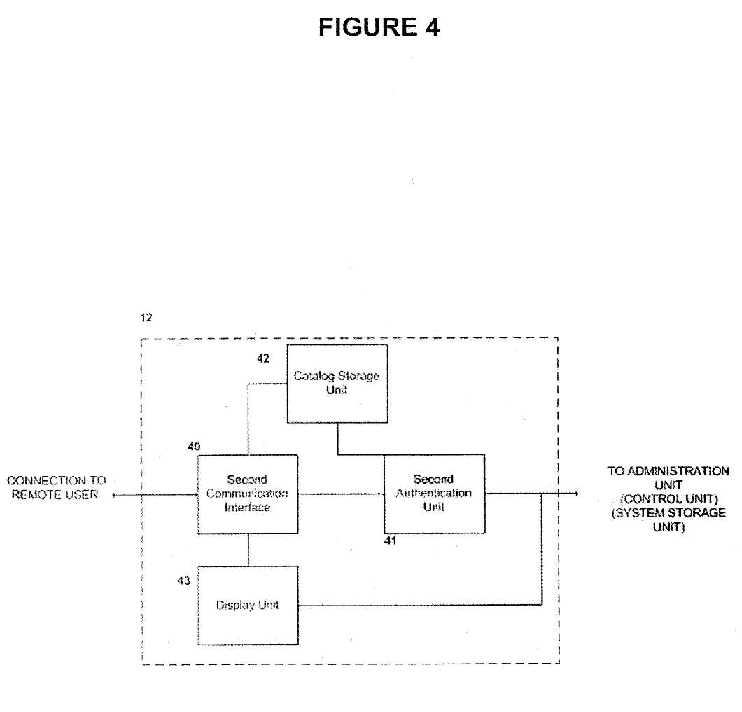

The catalog unit 12 is described further with reference to FIG. 4. Operation of the catalog unit 12 varies slightly depending on whether a user to whom selected data is sent from the catalog unit 12 is a managed user or an unmanaged user. Managed users have little or no control over what data is sent to their computers. A client agent may be provided on a managed user's computer to aid in reception of the data that is sent to the user based on the administration information received by the administration unit 14. Unmanaged users, that is, users who are not managed users, may determine what data is sent to them, or their computer, from the catalog unit 12. Unmanaged clients may, however, utilize a client agent to allow for certain functions without surrendering control of the data sent to them completely. The structure of the catalog unit 12 is substantially the same whether it serves a managed or unmanaged user.

The catalog unit 12 preferably includes a second communication interface 40 which establishes a connection between the catalog unit 12 and a user, preferably via the network. More specifically, the second communication interface 40 connects the catalog unit 12, which is preferably embodied as a web service, as mentioned above, with a computer of the user via the network. The second communication interface 40 also allows the catalog unit 12 to communication with the update unit 10 and the administration unit 14.

The catalog unit 12 may include a second authentication unit 41which is substantially similar to the authentication unit 31 of the update unit 10. Users may pre-register by providing certain user registration information which can be used to authenticate the user and may be issued identification information such as a user name or password. These users are authenticated users. The identification information for the user may be included in the user registration information of each authenticated user. The user registration information related to each authenticated user may be stored in a catalog storage medium 42 in the catalog unit 12 itself, in the system storage unit 11, or in the administration unit 14, for example. Certain user permissions may also be granted to individual authenticated users as well, and these permissions may be stored with the user registration information for each authenticated user. For example, permissions may indicate what type of data may be sent to a specific authenticated user.

After the user establishes communication with the catalog unit 12, the user may enter their user identification information, this information is compared to the user registration information and more specifically, to the identification information for each authenticated user, by the second authentication unit 40. Where the user identification information matches that of an authenticated user, the user is deemed an authenticated user and may be sent selected data by the catalog unit 12. A user who has not registered with the system may not be sent selected data from the catalog unit 12, or may be allowed to receive certain limited data, for example, data related to registering with the system. In addition, the unauthenticated user may be allowed to send registration information so that the system 9 can send selected data to the user at a later time.

Where the authenticated user is an unmanaged user, the user has control over what information is sent to the user from the catalog unit 12. Upon authentication, the authenticated user may be provided with a list of data available for distribution to that specific authenticated user. The list includes all data available to the user from among all of the data received by the update unit 10. As noted above, some data may include policy objects which may dictate that the data is not available to certain users. In addition, certain permission information may be associated with each authenticated user indicating certain types of data that the user cannot be sent. For example, if a policy object indicates that certain data may not be downloaded by users in Canada, that data is not included in the list of available data sent to the user if the user is in Canada. Whether the authenticated user is in Canada may be determined based on the user registration information of the user.

The list of available data is preferably displayed to the user on a display of the user's Computer (not shown). Based on the list of available data, the user selects the data that they wish to receive. The selection is sent to the catalog unit 12 as the selection information indicating the information to be sent to the user via the catalog unit. A client agent may be utilized to provide the selection information and to send the selection information to the catalog unit 12.

The selected data, that is the data that the selection information indicates is desired by the user, may be sent to the user in discrete segments so that if the sending operation fails before all of the selected data is sent to the user, the operation may be continued at a later time from the point of the failure. This feature may require the use of a client agent on the user's computer. While managed clients generally utilize such a client agent, even an unmanaged client may utilize such a client agent in order to allow for certain functions without surrendering control what data is sent to the user. The client agent may keep track of what segments of data have been sent from the catalog unit 12 and received by the user, and may send reports back to the system 9 via the catalog unit 12 so that an accurate record of the data sent to the user can be kept. The reports may be stored with the user registration information of the authenticated user such that the catalog unit 12 can determine the last segment of data sent to the user simply by accessing the user registration information of the authenticated user.

After the data is sent to the authenticated user, the user may choose to install the data, if the data is a software program, for example, immediately, or may choose to install the software program at a later time. Alternatively, the downloaded software may include information which activates an automatic installation function on the user computer in conjunction with the client agent, if any, at the user side.

The catalog unit 12 is preferably scalable, such that an authenticated user may be provided with a list of several folders of available data. The catalog unit 12 preferably enables sending data even over low bandwidth communication lines. In addition, the catalog unit 12 may enable sending data even to low power user devices. Such a feature may require use of a client agent to ensure efficient downloading of data. For example, the catalog unit may communicate with a PDA device of the user, rather than a personal computer. In such a case, there may be limited bandwidth available for the transfer. In addition, since PDA devices are generally battery powered, the sending of the data may be handled differently in order to ensure efficiency and thus preserve battery power.

Managed clients or users have little or no control over the data sent to them from the catalog unit 12. Managed clients include a client agent, preferably including one or more plug-ins which aid in the automatic download of selected data to the managed user's computer. Preferably, the administration information provided via the administration unit 14 determines what data will be downloaded to the user. This will be discussed in further detail below with reference to the administration unit 14.

Where the user is a managed client, communication is established with the user computer in a manner similar to that described above. The authentication of the user is also provided in a manner similar to that discussed above with relation to unmanaged users. However, the client agent may automatically supply the identification information of the user. In addition, since the managed user does not control what data is sent from the catalog unit, a list of available data need not be sent to the user from the catalog unit 12. Similarly, the user need not provide selection information indicating the selected data that the user wishes to receive. In the case of a managed user, the selection information is preferably included in the administration information provided via the administration unit 14.

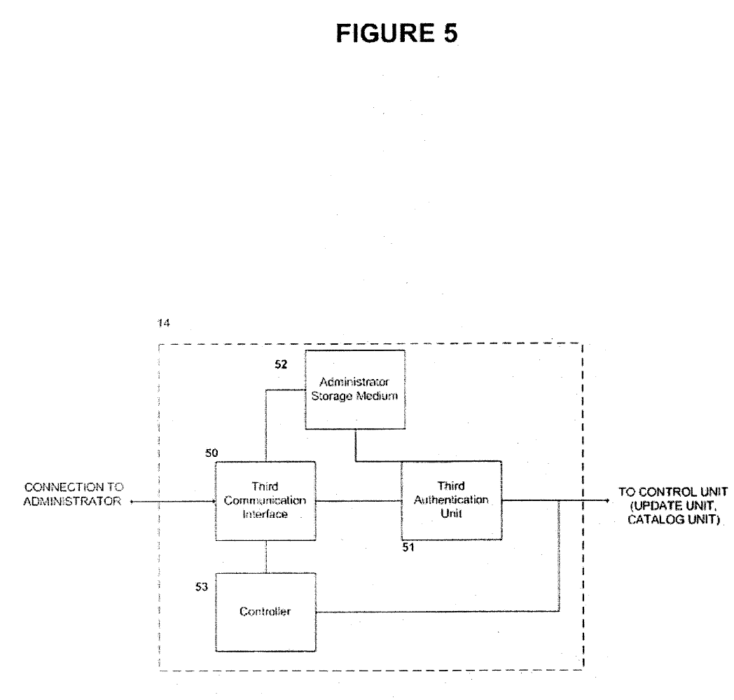

The administration unit 14 allows an administrator to administer the system and is described with reference to FIG. 5. The administration unit 14 preferably includes a third communication interface 50 which provides a connection between the administrator and the administration unit 14. More specifically, the third communication interface 50 connects the administration unit 14, which is preferably embodied as a web service, as mentioned above, with a computer of an administrator via the network. The administration unit 14 preferably includes a third authentication unit 51 to authenticate an administrator of the system similar, to the authentication unit and second authentication unit 31,41 of the update unit 10 and catalog unit 12, respectively, to authenticate an administrator of the system 9. The third authentication unit 51 operates in substantially the same manner as the authentication unit 31 and the second authentication unit 41, however, since there is typically only one authentic administrator for the system 9, the third authentication unit 51 may only compare administrator identification information provided by the administrator to administrator registration information of the one authenticated administrator. Nevertheless, it may be possible to have multiple administrators, in which case, the third authentication unit operates substantially the same as the authentication unit 31 and the second authentication unit 41 by comparing administrator identification information to administrator registration information of several authenticated administrators.

In a preferred embodiment, a client agent is included at the administrator side, that is, on the computer of the administrator, to facilitate administration. As noted above, the administrator may add and delete registered suppliers and/or users from the system via the administration unit 14. The administrator may also determine the permissions of the authenticated users and data suppliers of the system 9. As noted above, the permission information of authenticated users and data suppliers may be stored with the registration information for each authenticated user or authenticated supplier, respectively. The registration information of authenticated suppliers and authenticated users, respectively, may be stored in administration storage medium 52 in the administration unit 14, or in the system storage medium 11, as mentioned above. Alternatively, the registration information may be stored at a storage medium (not shown) connected to the remote administrator's computer, as well.

The administrator may also determine what data is sent to managed users. That is, the administration information may include selection information used to indicate the selected data to be sent to a managed user, or users by the catalog unit 12. The administrator may set up user groups and assign permissions to the group of users. The administrator may create an address book of users including addresses of groups of users. In addition the administrator may indicate periodic distribution of certain data to groups of users. For example, where a group includes all users who have downloaded a specific software program, the administrator may direct a periodic download of any updates of that program to each user in the group. The administrator may also generate reports indicating downloads to specific users or groups of users. In general, the administration information controls the update unit 10 in accordance with the permission information associated with the data supplier. In addition, the administration information controls the catalog unit 12 in accordance with the policy objects associated with certain data to prevent sending the data to ineligible users and in accordance with the user permission information to prevent the catalog unit 12 from sending data to an ineligible user.

In one embodiment of the present disclosure, a control unit 16 may be provided to control and coordinate the reception of data via the update unit 10 and sending of selected data to users via the catalog unit 12, based on the administration information provided from the administration unit 14. Where the supplier registration data and the data provided by the data supplier is stored in the system storage unit 11, the control unit 16 is preferably used such that only the control unit need be connected to the system storage unit and the control unit 16 provides the supplier registration information and the user registration information to the update unit 10 and the catalog unit 12, respectively. Alternatively, the administration unit 12 may directly control the update unit 10 and catalog unit 12. In this case a controller 53 may be provided in the administration unit 16 to control the update unit 10 and the catalog unit 12 based on the administration information and/or the permission of specific users and suppliers.

Some of the functions provided in the system described herein are made possible by use of so called client agents at the data supplier side, user side or administrator side. More specifically, client agents are installed in the computer of the data supplier, user and administrator, respectively. The client agents may include a lightweight client agent core. The specific function of the client agent depends on the supplier, user or administrator using the client agent. The client agent core may allow for various plug-ins to be plugged into the client agent core to achieve the desired functionality. For example, a client agent may be included on the data supplier side to support restarting of the upload operation after a failure. In this case, a plug-in which monitors the upload of data would be useful. As another example, both managed and unmanaged users may use a client agent to support a function for restarting a download after a download operation has failed. In this case a download plug-in would be useful to monitor the discrete download of segments of data. The download plug-in may be sensitive to bandwidth restrictions between the user and the system to optimize the download process. Other examples of useful plug-ins include a scheduler plug-in which may be utilized to schedule a future upload or download operation. A managed client plug-in is useful for managed clients. Such a managed client plug-in may be used to determine whether data should be downloaded to a client, may provide for installation of downloaded data, such as a software program on the user computer and may reports back to the system regarding the successful download of data to the client.

The present disclosure has described a single data distribution system. An alternative embodiment, however, provides for cooperation between multiple software delivery systems linked together, may be via the network. These multiple distribution systems may be linked together via the network such that one distribution system may communicate with a neighboring system. In such a case, each system may include a global address book including groups of users for all of the systems. This global address book may be synchronized between all systems. A distribution to a group of users at one distribution system may be distributed to all users of all systems in that group. For example, where a group includes users who use a specific software program and a distribution is made to a group at one distribution system, the data may be distributed to all users of that software program at all of the distribution systems. Hence a distribution may be made to many users at the same time without taxing the resources of any one distribution system.

Generally, users will log onto the specific distribution system at which they are registered so that registration information associated with that user need only be maintained at one system. However, users may be able to receive data from any of the distribution systems. That is, data may be sent from a system in the UK to a system in the US so that the client can download the software while logged into the US system.

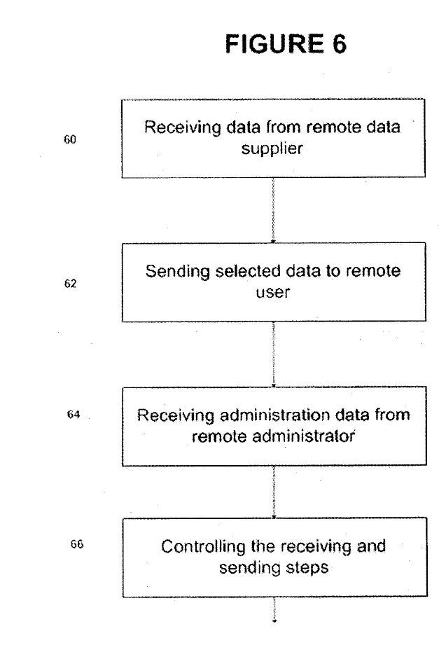

A method of distributing data via a computer network according to an embodiment of this disclosure is described with reference to FIG. 6. The method includes steps of receiving data from a data supplier in electronic format, step S60, sending selected data to a remote user based on selection information indicating the selected data to be sent, step S62, receiving administration information from a remote administrator, step S64, and controlling the steps of receiving data and sending selected data based on the administration information, S66.

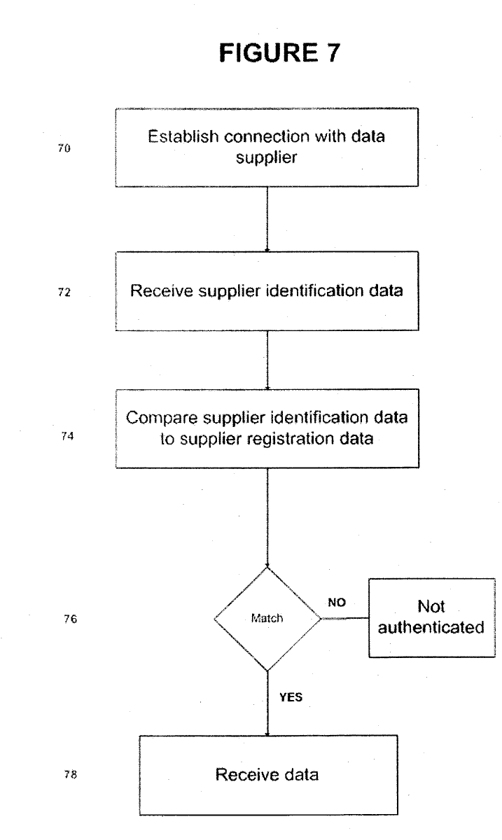

The step of receiving data is further described with reference to FIG. 7. Step S60 may include a step of establishing communication with a data supplier (S70). This may be accomplished by establishing a connection on the network between the supplier and an update unit of t data distribution system. At step S72, supplier identification information is received from the remote data supplier. At step S74, the supplier identification data is compared to registration data corresponding to a plurality of authenticated data suppliers. When the supplier identification information matches identification information included in registration information of an authenticated supplier (Yes at step S76), the data supplier is authenticated and data may be received from the data supplier (S78). Otherwise (No at step S76), data from the unauthenticated data may not be received. Alternatively, restricted data, such as registration information of the unauthentic data supplier may be received. Data may be received from the data supplier in discrete segments and may include type information indicating the type of data and parameters to be met regarding distribution of the data. The data may be stored in a storage medium in a folder, or destination folder, the name of which may be provided by the supplier. Supplier permission information associated with the registration information of the authenticated data supplier determines whether the supplier has permission to name the destination folder for the data. If the reception of data is interrupted, the reception process may be restarted at the same point at a later time. Policy objects may also be included in the data received from the data supplier indicating conditions under which the data is to be sent to users.

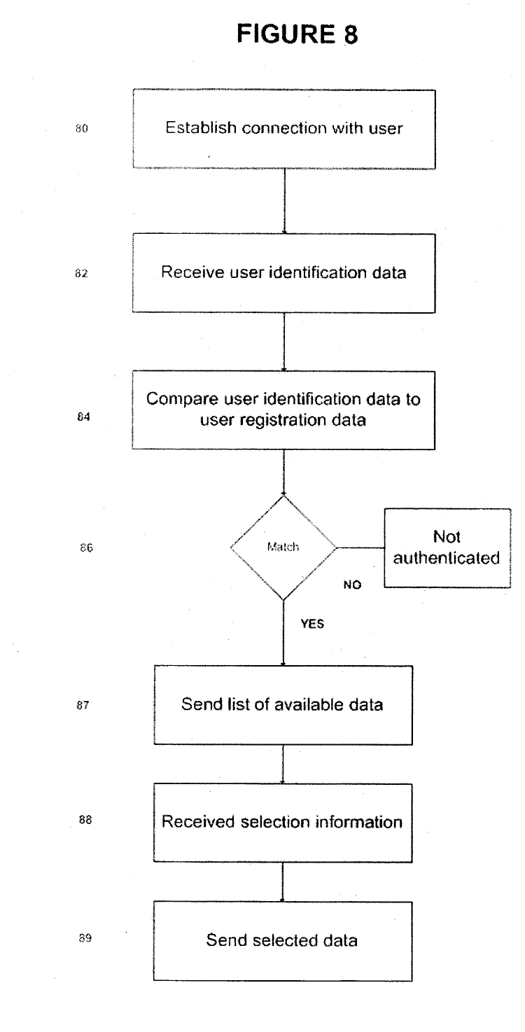

The step of sending selected data to the remote user, S62, is described further with reference to FIG. 8. The step of sending selected data to the remote user may include a step of establishing, a connection with the remote user, S80, preferable via the network. Upon establishing the connection, user identification information may be received (S82). The user identification information may be compared to previously received user registration information for each of a plurality of authenticated users (S84). Where the user identification information matches identification information of an authenticated user which is stored with the user registration information (Yes at step S86), the user is authenticated. Authenticated users may be sent selected data via a catalog unit. A user who is not authenticated (No at step S86) may be sent certain data, for example, information on how to register and become an authenticated user or may not be sent any data. In a preferred embodiment, a list of data that is available to the specific user is sent to the user, (S87). The user may then select the selected data, (S88), from the list of data available to the user. The selection is received by the catalog unit as selection information indicating the selected data desired by the user. Selected data indicated by the selection information is then sent to the user from the catalog unit via the network, for example (S89). Data may be sent in discrete segments such that if the sending operation is interrupted, sending of the selected data may be continued at a later time at the same point at which the failure took place.

In an alternative embodiment, the user is a managed user. In this case, the user has little or not control over what data is sent to the user. In this case, the administration information determines the selected data which is sent to the user. That is, the selection information is included in the administration information and the selected data sent to the user is determined by the registration information.

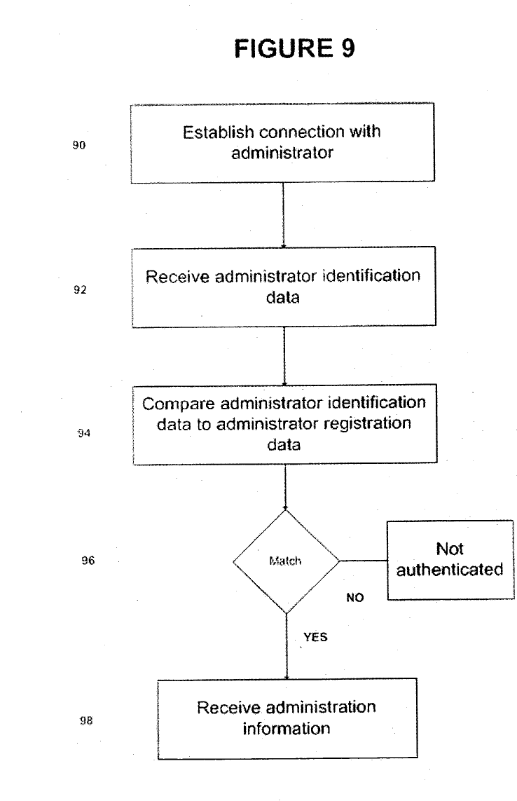

The step of receiving administration data from an administrator 64 is further described with reference to FIG. 9 and may include a step of establishing a connection with the remote administrator (S90). In step S92, administrator identification data may be received. When the administrator identifying data is compared to administrator registration data (S94) and it matches identification information relating to an authenticated administrator who has provided administrator registration information previously (Yes at step S96), the administrator is an authenticated administrator and the administration information they send will be received by an administration unit (S98). Non-authenticated administrators (No at step S96) may not be permitted to provide administration information for receipt by the administration unit.

The administration information may also include information regarding permissions granted to individual suppliers or users. The reception of data from data suppliers and sending of selected data to users is controlled based on the administration information. In addition, the administration information may indicate what data is to be sent to managed clients and whether a managed client may also be permitted to select other data to be downloaded.

It is noted the method described above is substantially implemented by the data distribution system described herein.

The present disclosure may be conveniently implemented using one or more conventional general purpose digital computers and/or servers programmed according to the teachings of the present specification. Appropriate software coding can readily be prepared based on the teachings of the present disclosure. The present disclosure may also be implemented by the preparation of application specific integrated circuits or by interconnecting an appropriate network of conventional components.

Numerous additional modifications and variations of the present disclosure are possible in view of the above-teachings. It is therefore to be understood that within the scope of the appended claims, the present invention may be practiced other than as specifically described herein.

What is claimed is:

1. A system for distributing data electronically via a computer network comprises:
an update unit adapted to receive data in electronic format from at least one data supplier;
a catalog unit adapted to send selected data from the data received by the update unit to a user in electronic format based on selection information; and
an administration unit adapted to control reception of data by the update unit and sending of selected data by the catalog unit based on administration information received from an administrator.

2. The system of claim 1, wherein the update unit, catalog unit and administration unit are embodied as web services, respectively.

3. The system of claim 2, wherein the update unit further comprises:
a communication interface adapted to allow communication with the data supplier, the catalog unit and the administration unit, respectively, via the computer network; and
an authentication unit adapted to authenticate the data supplier by comparing supplier identification information provided by the data supplier to stored supplier registration information corresponding to at least one authenticated data supplier, such that only data from an authenticated data supplier is received by the update unit.

4. The system of claim 3, wherein the data received by the update unit is received in discrete segments, such that when reception of data from the data supplier is interrupted, and reception continues at a later time from a last segment of data received from the data supplier.

5. The system of claim 4, wherein the data received from the data supplier includes policy objects indicating conditions under which the data is sent to users.

6. The system of claim 5, wherein the data received by the data supplier includes storage information indicating a folder name in which the data is stored.

7. The system of claim 2, wherein the catalog unit further comprises:
a second communication interface adapted to allow communication with the user, the update unit, and the administration unit, respectively, via the computer network; and
a second authentication unit adapted to authenticate the user by comparing user identification information provided by the user to stored user registration information corresponding, to at least one authenticated user, such that the selected data is only sent to an authenticated user.

8. The system of claim 7, wherein the catalog unit provides a list of available data including, data that is available to the user and sends the list of available data to the user via the second communication interface.

9. The system of claim 8, wherein the second communication interface is adapted to receive selection information from the user indicating the selected data that the user wishes to be sent by the catalog unit.

10. The system of claim 7, wherein the selection information indicating the selected data to be sent by the catalog unit to the user is included in the administration information.

11. The system of claim 9, wherein the selected data sent by the catalog unit to the user is sent in discrete segments such that when the sending of the selected data is interrupted, sending of the selected data is resumed at a later time starting from a last segment of selected data sent to the user.

12. The system of claim 2, wherein the administration unit further comprises:
a third communication interface adapted for communication with the administrator, the update unit and the catalog unit, respectively, via the computer network; and
a third authentication unit adapted to authenticate the administrator by comparing administrator identification information provided by the administrator to stored administrator registration information corresponding to at least one authenticated user, such that the administration information is only received from an authenticated administrator.

13. The system of claim 12, wherein the administration information controls the catalog unit to prevent sending certain data to the user when a policy object indicates that the certain data is not be sent to the user.

14. The system of claim 13, wherein the administration information controls the catalog unit to prevent sending certain other data to the user when permission information related to the user indicates that the certain other data is not to be sent to the user.

15. The system of claim 14, wherein the administration unit further comprises:
an administration storage unit adapted to store the supplier registration information and the user registration information, respectively.

16. A method of distributing data in electronic format over a computer network comprises:
receiving data from at least one data supplier in electronic format;
sending selected data to a user in electronic format based on selection information;
receiving administration information from an administrator; and
controlling the step of receiving data and the step of sending selected data according to the administration information.

17. The method of claim 16, wherein the steps of receiving data, sending selected data, receiving administration information and controlling are performed by a plurality of web services communicating via the network.

18. The method of claim 17, wherein the step of receiving data further comprises:
establishing a connection between the data supplier and an update unit adapted to receive the data from the data supplier; and
authenticating the data supplier, wherein only data from an authenticated data supplier is received in the receiving step.

19. The method of claim 18, wherein the authenticating step further comprises:
receiving supplier identification information from the data supplier; and
comparing the supplier identification information to stored supplier registration information corresponding to at least one authenticated data supplier, such that the data supplier is all authenticated data supplier when the supplier identification information matches the supplier registration information of at least one authenticated data supplier.

20. The method of claim 19, wherein the data received from the data supplier is stored in a storage unit.

21. The method of claim 20, wherein the data received from the data supplier is received in discrete segments such that when the step of receiving data is interrupted, the step of receiving data is continued at a future time at a point of interruption.

22. The method of claim 21, wherein the data received from the data supplier includes storage information indicating a folder name in which the data is stored in a storage unit.

23. The method of claim 22, wherein the data received from the data supplier includes, policy objects indicating conditions under which the data is sent to the user.

24. The method of claim 23, wherein the step of sending selected data comprises:
sending a list of available data to the user, wherein the available data is specific data available to the user from among the data received in the step of receiving data; and
receiving selection information from the user indicating the selected data to be sent to the user in the step of sending selected data.

25. The method of claim 24, wherein the selection information is included in the administration information.

26. The method of claim 25, wherein the step of receiving administration information further comprises:
establishing a connection between the administrator and an administration unit; and
authenticating the administrator, wherein only administration information provided by an authenticated administrator is received.

27. The method of claim 26, wherein the step of authenticating the administrator further comprises:
receiving administrator identification information provided by the administrator; and
comparing the administrator identification information to administrator registration information corresponding to at least one authenticated administrator such that the administrator is authenticated when the administrator identification information matches the administrator registration information of at least one authenticated administrator.

28. The method of claim 27, wherein the step of controlling further comprises:
storing the supplier registration information, the user registration information and the administrator registration information in the administration unit.

29. The method of claim 28, wherein the step of controlling includes preventing the sending of certain data to the user where a policy object associated with the data restricts sending of the data.

30. The method of claim 28, wherein the step of controlling include preventing the sending of certain other data to the user where permission information associated with the user prevents the user from being sent the certain other data.

31. A computer system comprising:
a processor; and
a program storage device readable by the computer system, embodying a program of instructions executable by the processor to perform method steps for distributing data, the method steps comprising:
receiving data from a remote data supplier in electronic format;
sending selected data to the user in electronic format;
receiving administration information from a remote administrator; and
controlling the step of receiving data and the step of sending selected data according to the administration information.

32. The computer system of claim 31, wherein the steps of receiving data, sending selected data, receiving administration information and controlling are performed by a plurality of web services communicating via the network.

33. The computer system of claim 32, wherein the step of receiving data further includes:
establishing a connection between the data supplier and an update unit adapted to receive the data from the data supplier; and
authenticating the data supplier, wherein only data from an authenticated data supplier is received in the receiving step.

34. The computer system of claim 33, wherein the authenticating step further comprises:
receiving supplier identification information from the data supplier; and
comparing the supplier identification information to stored supplier registration information corresponding to at least one authenticated data supplier, such that the data supplier is an authenticated data supplier when the supplier identification information matches the supplier registration information of at least one authenticated data supplier.

35. The computer system of claim 34, wherein the data received from the data supplier is stored in a storage unit.

36. The computer system of claim 35, wherein the data received from the data supplier is received in discrete segments such that when the step of receiving data is interrupted, the step of receiving data is continued at a future time at a point of interruption.

37. The computer system of claim 36, wherein the data received from the data supplier includes storage information indicating a folder name in which the data is stored in a storage unit.

38. The computer system of claim 37, wherein the data received from the data supplier includes policy objects indicating conditions under which the data is sent to the user.

39. The computer system of claim 38, wherein the step of sending selected data comprises:
sending a list of available data to the user, wherein the available data is specific data available to the user from among the data received in the step of receiving data; and
receiving selection information from the user indicating the selected data to be sent to the user in the step of sending selected data.

40. The computer system of claim 38, wherein the selection information is included in the administration information.

41. The computer system of claim 40, wherein the step of receiving administration information further comprises:
establishing a connection between the administrator and an administration unit; and
authenticating the administrator, wherein only administration information provided by an authenticated administrator is received.

42. The computer system of claim 41, wherein the step of authenticating the administrator further comprises:
receiving administrator identification information provided by the administrator; and
comparing the administrator identification information to administrator registration information corresponding to at least one authenticated administrator such that the administrator is authenticated when the administrator identification information matches the administer registration information of at least one authenticated administrator.

43. The computer system of claim 42, wherein the step of controlling further comprises:
storing the supplier registration information, the user registration information and the administrator registration information in the administration unit.

44. The computer system of claim 43, wherein the step of controlling includes preventing the sending of certain data to the user where a policy object associated with the data restricts sending of the data.

45. The computer system of claim 44, wherein the step of controlling include preventing the sending of certain other data to the user where the permission information associated with the user prevents the user from being sent certain data.

46. A program storage medium, readable by a computer system, embodying a program of instructions executable by the computer system to perform method steps for distributing data in a computer network, the method steps comprising:
receiving data from a remote data supplier in electronic format;
sending selected data to the user in electronic format;
receiving administration information from a remote administrator; and
controlling the step of receiving data and the step of sending selected data based on the administration information.
